(19) United States
(12) Patent Application Publication
(10) Pub. No.: US 2010/0132019 A1
(43) Pub. Date: May 27, 2010

(54) REDUNDANT MULTIFACTOR AUTHENTICATION IN AN IDENTITY MANAGEMENT SYSTEM

(75) Inventor: Dick Clarence Hardt, Vancouver (CA)

Correspondence Address: PERLEY-ROBERTSON, HILL & MCDOUGALL LLP, 1400-340 Albert Street, OTTAWA, ON, K1R 0A5, CA

(73) Assignee: SXIP IDENTITY CORP., Vancouver, BC (CA)

(21) Appl. No.: 12/594,368

(22) PCT Filed: Apr. 4, 2008
(86) PCT No.: PCT/CA2008/000612

§ 371 Date: Oct. 19, 2009

Related U.S. Application Data
(60) Provisional application No. 60/909,978, filed on Apr. 4, 2007.

(51) Int. Cl. H04L 9/32

(52) U.S. Cl. 726/6

(57) ABSTRACT

A redundant multifactor identity authentication system provides users with a secure mechanism for providing identity information through the use of redundant independent identity providers in concert with each other so that resources are accessed only through a combination of providers. By eliminating reliance on a single provider, security is increased as is reliability. Similarly, redundant credentials can be provided to relying parties to ensure that the relying party receives proof of a credential without requiring a specific credential.

### CROSS REFERENCE TO RELATED APPLICATIONS

This application claims the benefit of priority of U.S. Provisional Patent Application No. 60/909,978 entitled “Redundant Multifactor Authentication In An Identity Management System” filed Apr. 4, 2007, which is incorporated herein by reference in its entirety.

### FIELD OF THE INVENTION

The present invention relates generally to redundant and multifactor authentication in identity management systems. In particular the present invention relates to the use of multiple independent identity management systems to provide enhanced security and reliability, as well as to provide alternate credential provision facilities.

### BACKGROUND OF THE INVENTION

In the field of identity management, persona identification is stored in a repository, typically in the form of identity claims. The persona identification is stored by an Identity Provider (IdP), which has also been referred to as a homesite. The IdP can be either local to a user, allowing the user to store identity information locally, or remote from the user and accessible via a network connection, over networks such as the Internet.

The use of a remote system provides availability of identity information from any computer that can access the remote IdP, and thus can allow a platform agnostic identity management system. A downside to the use of a remote IdP is that the user is no longer in control of the identity information. If there is a loss of connectivity to the IdP, the user cannot access the remotely stored identity information. A local identity manager can be employed to use locally stored biometric information as an authentication mechanism, but is vulnerable to physical loss if it is a peripheral device or is installed locally on a user system.

To allow for redundant access, users can employ multiple identity providers making each of them authoritative at a single resource. Implementation of such systems will be understood by those skilled in the art.

When a remote entity is authoritative for identity information associated with a user persona, the user must trust the security of the IdP, and must also trust that the IdP will not become a rogue entity and begin impersonating the user. The user must also protect the login information associated with the persona at the IdP. If the login information becomes known, the account is compromised, and the user can lose control of the account. In the case of a local IdP, software is typically installed either on a dedicated hardware element or is installed as a local application. This software relies upon authentication of the user by known means including the operating system login authentication, a fingerprint scan or a password. If physical possession of the hardware element, or computer system is lost, through theft or misplacement, a loss of control of the IdP logins results.

With many remote systems, the user can be provided with a mechanism to lock an account, or to reset login information, which may allow a user to reclaim access to the account upon detection of loss or compromise. This may provide the user with a mechanism to reclaim the persona, but can also serve as a mechanism to allow a malicious third party to prevent the user from gaining any access to the system by changing a password. With local IdP's there may be no mechanism to allow user to recover identity information if the local IdP is lost or erased.

To protect persona identity information stored at an IdP, the use of multi-factor authentication to the Identity Provider has been discussed. Compromise of a number of different authentication factors is seen as statistically more difficult than compromise of a single factor. This does not address the issue of guaranteed availability nor does it prevent an IdP from acting to impersonate a user.

A similar problem is raised when a relying party requests that a user provide an identity claim that is tightly bound to a real-world identity. Typically, identity management systems serve to provide a user with a mechanism to prove that she is the same entity that previously used the resource. When the user is required to provide identity information that would serve as the equivalent to government identification, or professional qualifications, the matter becomes more difficult, as there is often a single identity claim that must be relied upon. Often this single identity claim provides relies upon a central authority. Although this gives a degree of trust due to the centralization of authority, it still provides a single point of failure.

Accordingly, it is, therefore, desirable to provide a system that provides a secure identity management system that allows for multiple credential provision mechanisms, and provides both secure and redundant access to stored personal identity profiles.

### SUMMARY OF THE INVENTION

One object of the present invention to obviate or mitigate at least one disadvantage of previous identity providers and credential provision systems.

In a first aspect of the present invention there is provided a user identity agent for communicating with identity providers and relying parties in an identity management network. The identity agent comprises a relying party interface, an identity provider interface and a credential processor. The relying party interface receives requests for identity information from a relying party and transmits an aggregated credential to the relying party in response to the received request for identity information. The identity provider interface transmits requests for a credential to at least one identity provider in accordance with the received request for identity information, and receives the requested credential from the at least one identity provider. The credential processor receives credentials through the identity provider interface and aggregates the credentials to create the aggregated credential transmitted to the relying party through the relying party interface.

In an embodiment of the first aspect of the present invention, the requests for identity information include requests for a plurality of identification credentials. In another embodiment, the identity provider interface transmits a request for a credential to a plurality of identity providers, where the credential can be a unique identifier used to identify a user to the relying party.

The identity agent can also include a database for associating a relying party with the at least one identity provider transmitting a credential supplied to the relying party. The database can be accessible to the credential processor for storing the at least one identity provider associated with credentials aggregated and transmitted to the relying party, and the associated relying party. The credential processor can also include an identity provider selector for selecting at least one identity provider determined in accordance with both the relying party and the at least one identity provider associated with the relying party in the database. The selector can also request credentials from the selected at least one identity provider through the identity provider interface in response to a request for identity information received through the relying party interface. The requests for identity information from a relying party can include a request for a strong identity credential, and the aggregated credential transmitted in response to such a request can include a set of identity credentials that in combination are acceptable to the relying party as a strong identity credential.

In a second aspect of the present invention, there is provided a method of registering a set of user credentials generated by a plurality of identity providers with a relying party. The method comprises the steps of obtaining the set of credentials from each of the identity providers in the plurality, each of the identity providers supplying one credential in the set; and enrolling the set of credentials with the relying party by transmitting a request to associate the set of credentials with a user.

In embodiments of the second aspect of the present invention, the method can also include the step of storing a list of the identity providers associated with each of the credentials in the set in a database and associating the list with the relying party. In another embodiment, the step of enrolling the set of credentials includes requesting that the relying party associated the set of credentials with a new user account, and optionally further includes storing a relying party policy specifying the number of credentials in the enrolled set required to allow a later login.

In an alternate embodiment, the relying party has an existing set of credentials associated with the user, and the step of enrolling the set of credentials includes requesting that the relying party replace the existing set with the transmitted set. The transmitted set of credentials can include both credentials from the existing set and new credentials.

In a third aspect of the present invention, there is provided a method of logging in to a relying party using a set of credentials. The method comprises the steps of receiving a credential request from the relying party; determining a set of credentials previously supplied to the relying party; obtaining a subset of the determined set; and transmitting the obtained subset to the relying party.

In one embodiment of the present invention, the step of transmitting the obtained subset includes aggregating the subset and transmitting the aggregate to the relying party. In another embodiment, the obtained subset has fewer credentials than the determined set. The number of credentials in the obtained subset can be determined in accordance with a policy set by the relying party.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an illustration of a system of the present invention illustrating enrollment and login in a network setting;

FIG. 2 is an illustration of a system of the present invention illustrating replacement and login in a network setting;

FIG. 3 is a block diagram illustrating logical elements of a user identity agent;

FIG. 4 is a flowchart illustrating a method of enrolling a series of credentials with a relying party;

FIG. 5 is flowchart illustrating a method of logging in using a set of credentials;

FIG. 6 is a flowchart illustrating a method of replacing one credential from a set of enrolled credentials; and

FIG. 7 is a block diagram illustrating the submission of a plurality of credentials to a relying party.

### DETAILED DESCRIPTION

Generally, the present invention provides a method and system using redundant and/or multifactor authentication to provide a secure identity management system.

Redundancy has been previously discussed as a mechanism to provide users with access to identity information in the event that a preferred IdP is inaccessible. Redundancy is created by having a user create a relationship with a number of IdP's, and allowing any of the IdP's to authenticate a login. This provides the user with the ability to rely upon a number of IdP's. However, if access to one of the IdP's is compromised, the user can be impersonated, and redundant IdP's cannot prevent this. Even if there is a provision to allow a user to reclaim the access to a compromised remote IdP, loss of a physical IdP cannot be protected against.

In a conventional system, a user may have a plurality of IdP's, each of which store identity information, this identity information may be synchronized between the IdPs. A Relying Party (RP) provides a service, or access to a service for a user. The relying party provides the user access based on the receipt of a token from one of the IdP's. This token can be viewed as a credential. Each of a plurality of IdP's provides the RP with a token that the RP considers equivalent to a token from any of the other IdP's. When one IdP is unavailable, the user can make use of an alternate IdP to provide the token. However, one skilled in the art will appreciate that in such a model, increasing the number of IdP's increases availability, but decreases the overall security of the system as it provides additional points of failure and compromise. If the user relies upon a number of different entities to store redundant identity information, there are more entities that could go rogue and impersonate the user, there are more entities that could have their security attacked in an attempt to compromise the overall user database, and there are more accounts for which secure passwords must be created. The security of the system is limited to the weakest security of any IdP hosting the data. Thus having multi-factor authentication, which is commonly regarded as a robust security system, is of little value unless all the IdP's make use of multi-factor authentication. Increasing the number of passwords and security challenges at each of a number of IdP's may have the effect of making the system less secure as users have a tendency to select more basic authentication secrets when a greater number are selected. Thus multi-factor authentication at a number of IdP's may result in users selecting very basic passwords at each site, and possibly the same password at all sites, thus allowing compromise of one system to result in compromise of other systems.

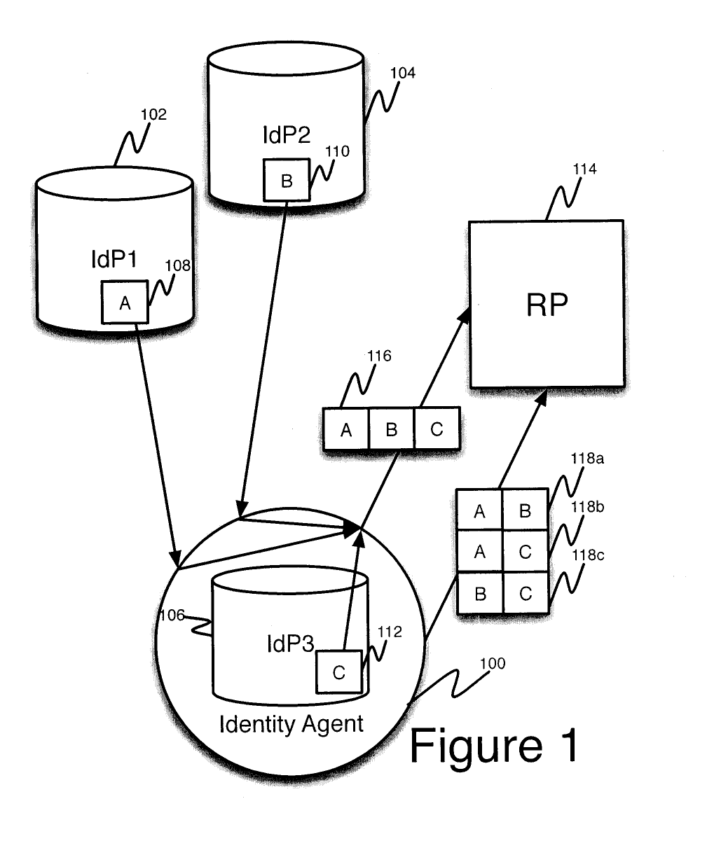

To address this issue, the present invention makes use of a plurality of IdP's, each of which are independent of each other. These IdP's may be synchronized, but the credential tokens that are generated to provide users with access to resources at particular RP's are distinct between the IdP's. FIG. 1 illustrates a system of the present invention. In FIG. 1, a user identity agent 100 is used to connect the user to a series of identity providers such as IdP1 102, IdP2 104 and IdP3 106. As illustrated, IdP1 102 and IdP2 104 are remote IdP's that are accessed using a network connection, and IdP3 106 is local to the agent 100. Each of the IdP's controls a credential, indicated as credential A 108 associated with IdP1 102, credential B 110 associated with IdP2 104, and credential C 112 associated with IdP3 106. When a user enrolls for service with relying party 114 (RP), RP 114 and the user agree to a level of security that provides redundant multifactor authentication. In response, RP 114 requests that the user agent 100 provide a set of credentials from different IdP's. This request can be for a defined number of IdP's, or can be a request for any number of IdP's that exceed a threshold. In the presently illustrated exemplary embodiment, IdP1 102, IdP2 104 and IdP3 106 are each used in the enrollment procedure. Each of the three identified IdP's provides its credential token to RP 114, preferably via the user agent 100 with a request to enroll the supplied credential tokens for the user account. Credentials 108 110 and 112 can be aggregated and the aggregate 116 can be transmitted to RP 114 by user agent 100. RP 114 stores these credentials as authentication information associated with the user account. When a user later accesses RP 114, any two of the three tokens must be provided. Thus, the acceptable credential pairs that can be used for later login are illustrated as credential pairs 118a 118b and 118c.

One skilled in the art will appreciate that because two of the three tokens are required for login to the resource at the relying party, redundancy is maintained. If a single IdP is unavailable for any reason, login to the resource is still permitted. Furthermore, security is increased. If a user loses control of an authenticated login at an IdP, through a compromised password, loss of a physical identity manager, or through a rogue IdP, the resource cannot be accessed without compromise of a second IdP. Thus, if IdP1 108 became unavailable due to either loss of connectivity or through going out of business, the user can still access RP 114 through the use of the IdP2 104 and IdP3 106. If IdP1 102 is access through a PIN or other password that is subsequently compromised, a malicious third party cannot impersonate the user to RP 114 without first obtaining access to other IdP's. If IdP1 102 goes rogue it cannot impersonate the user, as it would first need knowledge of what the other IdP's are, and then would require access to the IdP's. One skilled in the art will appreciate that just as redundancy increases the statistical availability of an IdP, redundant IdP's statistically increase the security, as impersonating a user requires compromise of a plurality of systems, or requires co-ordination of a plurality of rogue IdP's, each of which have overlapping accounts.

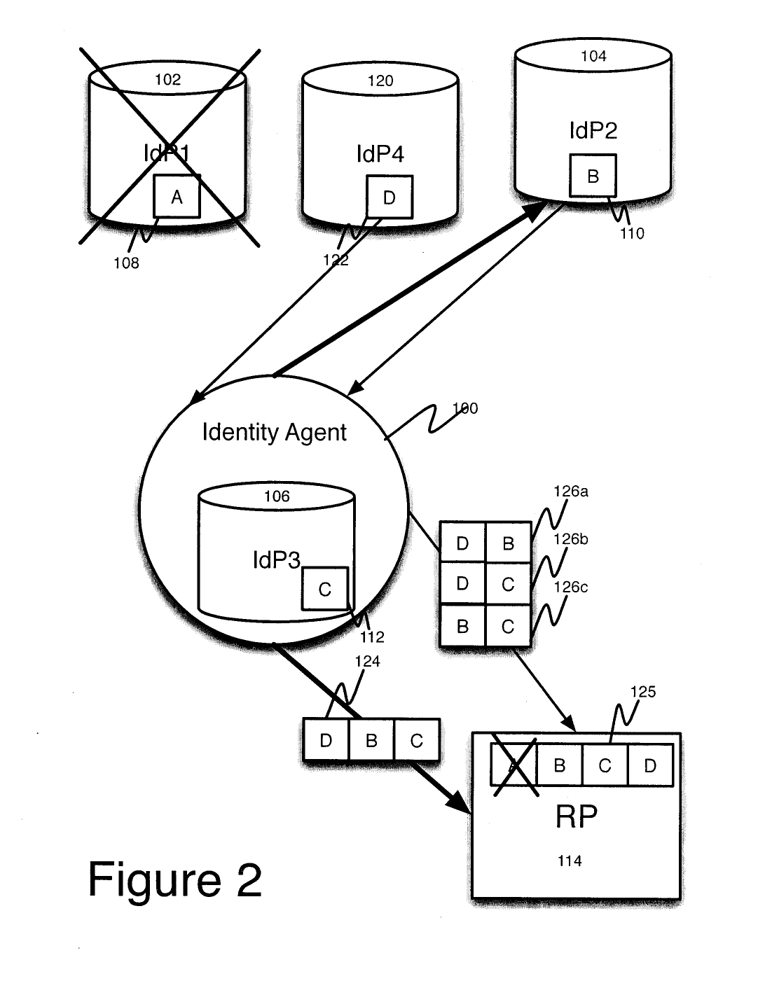

When an IdP is no longer used by a user, for any number of reasons, it is advantageous for the user to replace the unused IdP with a new IdP at RP 114. Removal and addition of an IdP can be performed through the submission of a specialized request accompanied by tokens associated with the user from the required number of IdP's, in this example two. FIG. 2 illustrates an exemplary replacement of an IdP.

The user determines that IdP1 102, which generates credential token A 108, is no longer to be used. Because of the availability of redundant IdP's, the user is still able to access RP 114. At this time, the user wishes to remove token A 108 as a legitimate login credential. A request is issued to the remaining IdPs (IdP2 104 and IdP3 106), either by the user agent 100 or by RP 114 (in which case the request can be sent either directly or via the user agent 100). The user then authenticates with both IdP2 104 and IdP3 106. RP 114 can establish a policy that the removal of an IdP, such as IdP1 102 requires that the user authenticate with the other IdP's using a specialized or secure authentication. This is illustrated using the bolded connection to IdP2 104. Instead of a password or PIN, the user may be required to provide a voice authentication, a biometric scan, or another piece of authentication information that is more secure than a simple password. This imposes a higher burden on the user for replacing an IdP than is required for standard logins to RP 114. This optional security can protect a user from malicious intervention by third parties. A connection is then made to a new IdP, IdP4 120. A credential token, token D 122, is obtained from IdP4 120, and is sent to RP 114 along with tokens B 110 and C 112 as aggregate 124. Tokens B 110 and C 112 can be sent in a specialized format indicating that they are providing approval of the addition of the new IdP and the removal of the previous IdP. At this time, RP 114 removes token A 108 from its list of acceptable authentication tokens 125 and adds token D 122. As a result, the user can now log in at RP 114 using any of the token combinations illustrated as 126a 126b and 126c.

One skilled in the art will appreciate that there is no theoretical limit to the number of IdP's that can be registered at RP 114, and the number of IdP tokens required for a login can be varied from a single token, which in combination with a plurality of registered tokens provides simple redundancy, to a number equal to the number of tokens registered, which results in no redundancy but a higher degree of security. It is recognized that it is most likely that systems of the present invention will make use of a plurality of IdP's, but will require tokens from a subset of the IdP's for a login, which provides a degree of redundancy while at the same time providing a multifactor authentication.

Because each IdP is responsible for authenticating the user prior to issuing the token, a set of different login methods can be employed at each of the IdP's to increase security and effectively provide multi-factor authentication. None of the IdP's needs to offer multi-factor authentication (although any of them can offer it), as the combination of the different IdP's forms a multi-factor authentication at the RP level.

It is foreseen that although a user has access to a number of different IdP's, each RP access does not need to be given the same number of IdP tokens, nor do the IdP's used for each RP have to form a common set. This may make administration more difficult for a user, but can be implemented by the RP and the IdP without any impact on implementation complexity. The management of which credential tokens are used at which RP can be managed by the user identity agent 100.

In the present invention, multi-factor authentication is provided at the RP-level through the use of multiple IdP's. Resources that a user does not consider to be essential, such resources that require login to provide display preferences, but otherwise do not interact with the user, can be set to work with any one of a plurality of IdP tokens registered with the RP (conceivably only one credential token could be provided). This allows the user to have a simplified login to these services. More important systems, such as sites that allow posting under a persona, may be set to require two credential tokens to prevent malicious misuse of the persona. Extremely secure systems, such as banking systems, may require three or more tokens to be provided. Thus a multi-tiered authentication system can be created using policies at individual RP's based on each RP's need for security, and possibly in conjunction with a user preference.

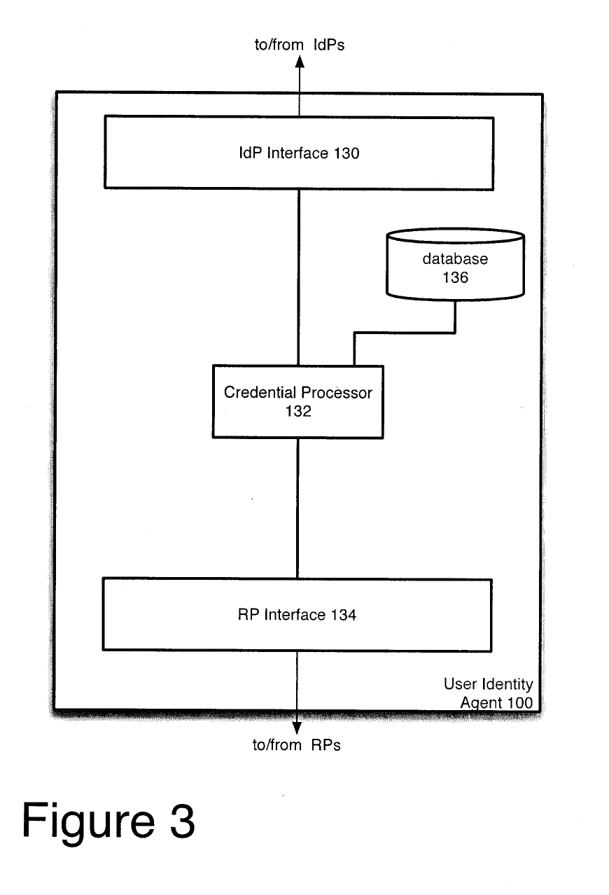

FIG. 3 is a block diagram illustrating an exemplary configuration of the logical elements of a user identity agent 100 of the present invention. The identity agent 100 connects to IdPs (not shown) through an IdP interface 130. The IdP interface 130 connects to IdPs to transmit requests for credentials and to receive the requested credentials. When a request for a credential is made to an IdP through IdP interface 130, the user may be required to authenticate to the IdP. This authentication communication can be done by the user at the IdP, or through the IdP interface 130, if user identity agent 100 manages the authentication functions for the user. A credential processor 132 generates the requests that are transmitted through IdP interface 130, and processes the credentials received in response to the requests. The credentials are often aggregated by the credential processor 132, and then transmitted to a relying party (not shown) through RP interface 134. Credential processor 132 can also make use of an optional database 136 to store a list of either credentials or IdP's associated with each RP.

When a user enrolls at an RP, the request for credentials to enroll at the RP is received by the user identity agent 100 through the RP interface 134, and is examined by credential processor 132. Credential processor 132 can determine how many credentials are required, and how may will be submitted. This determination can be done in accordance with policies established by the RP and in accordance with user preferences. Requests for credentials are then generated and transmitted to a set of IdPs through IdP interface 130. The credentials are once again received through IdP interface 130, are aggregated by credential processor 132 and are then transmitted to the RP through RP interface 134.

When a user visits an RP, the RP request for credentials is received through the RP interface 134. The credential processor 132 determines which IdP's to access to obtain the set of credentials needed for login to the RP, through examining the database 136. The credential requests are then transmitted to each IdP through IdP interface 130. The user then authenticates to the IdP, optionally through IdP interface 130, and the credentials are received by IdP interface 130 and forwarded to the credential processor 132. Credential processor 132 then aggregates the received credentials and transmits the aggregate to the RP through RP interface 134.

When changing credentials, the credential processor 132 generates the credential change request that is issued to the RP through RP interface 134, and obtains the credentials from the various IdPs through IdP interface 130. The list of credentials or IdPs associated with the RP can then be updated in the database 134.

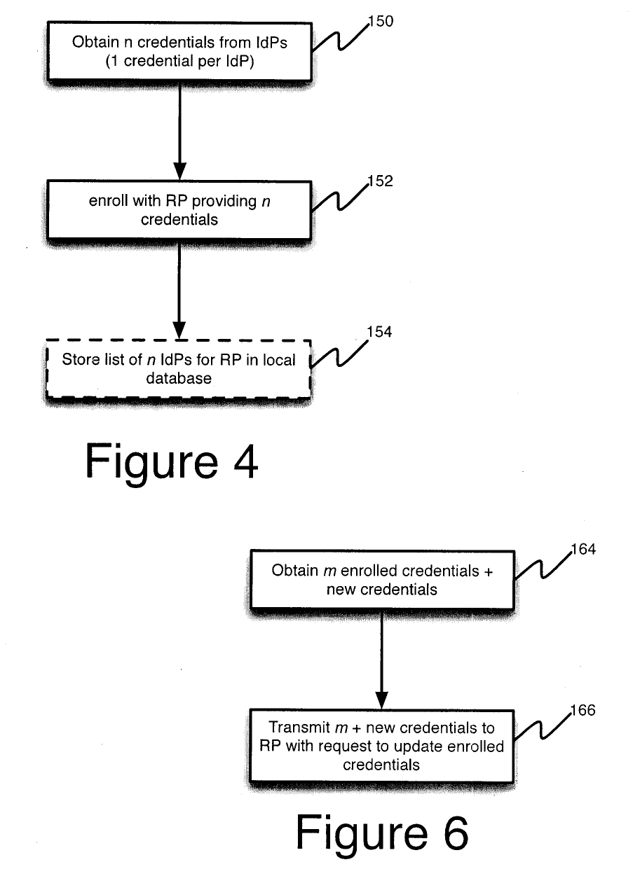

FIG. 4 illustrates a method of enrolling a user at an RP. The identity agent 100 obtains a set of n credentials from n IdPs in step 150. n can be determined in accordance with both user preferences and policies established by the RP. In step 152 the n credentials are then enrolled with the RP, and are associated with a new user account. Preferably, a list of the IdPs that generated the login credentials for the RP is stored so that varying combinations of IdPs can be used for different RPs, without requiring the user to keep track of these details, in step 154.

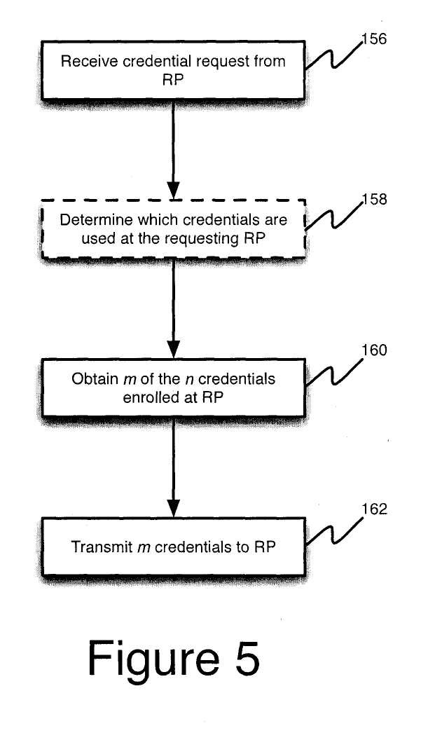

FIG. 5 illustrates a method of logging in to an RP following the enrollment method illustrated in FIG. 4. In step 156 a credential request is received from the RP. In optional step 158, the credentials enrolled at the RP are determined. In step 160, m of the n credentials enrolled with the RP are retrieved. The m credentials are then transmitted to the RP in step 162. The m credential can be aggregated prior to transmission in some embodiments of this method. One skilled in the art will appreciate that m can be less than or equal to n, but should be determined in accordance with the policies established by the RP.

FIG. 6 illustrates a method of removing credentials and enrolling replacement credentials with an RP. In Step 164, m credentials that have been enrolled with an RP are obtained from the respective IdPs, along new credentials to enroll. This set of credentials is then forwarded to the RP in step 166 with a request that the RP enroll the new credentials and remove credentials that are not included in the request. Thus, if n credentials were originally registered, and m=n new credentials are added to the list of credential enrolled with the RP. If m<n then the enrolled credentials not included in the set of m credentials are removed. If no new credentials are supplied, then none are added, and the request is simply a request to delete enrolled credentials. The minimum acceptable value of m is determined by the RP. One skilled in the art will appreciate that if a list of the credentials or IdP's used for a particular RP is maintained, it can be updated during this process so that the list is accurate.

The use of redundant credential tokens for a login to a single RP can also be extended to other purposes. The above described methods and systems provide a mechanism for a user to provide that he is the same entity that previously visited. Those skilled in the art will appreciate that despite being able to provide that the user is the same entity, there are occasions that a user is required to provide proof of an identity attribute. Such attributes may relate to actual real world identity, assert a real world credential, or provide an online attribute such as certification that the user is not a spammer. For the purposes of the following discussion a limited number of such instances will be discussed. This is not an attempt to be exhaustive, and instead is intended to be merely exemplary in nature. One skilled in the art will appreciate that other credentials can be provided to prove other requirements without departing from the scope of the present invention.

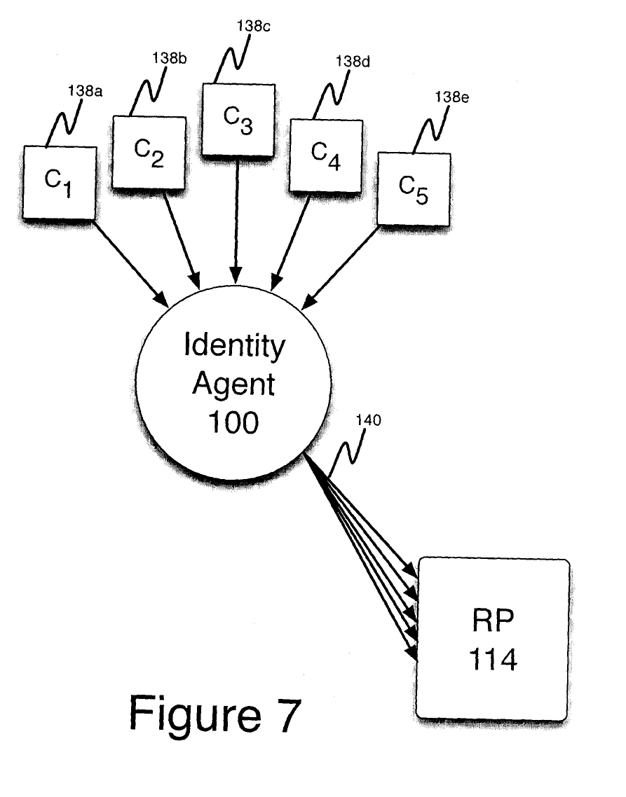

In an example, a user may be asked to provide proof of identity. It is often considered to be difficult for a user to provide evidence online of a real world identity, though it is often quite useful to be able to do so. An identity claim asserting real world identity issued by a government is often considered to be the gold standard of credentials asserting identity. However, it may be advantageous to provide users with the ability to prove identity using other resources. Much as before, the submission of a plurality of weaker credentials from a variety of sources can be used to provide reliability equivalent to a single stronger credential. In conventional systems, proof of identity is obtained by requesting a single strong credential. Because the single strong credential is issued from a central source, occasions may arise that prevent a user from obtaining credentials from the central source including a loss of connectivity at the credential-issuing site. Using the system illustrated in FIG. 3, a user identity agent 100 can receive a request for a strong identity credential, such as a government issued identity credential. Using a policy established by the RP 114, the identity agent 100 can initiate a connection to a plurality of different credential providers to obtain a series of weaker credentials. As illustrated in FIG. 7, a plurality of weaker credentials 138a-138e can be obtained by the user identity agent 100, and aggregated together for transmission to RP 114. The identity credential aggregate 140 is then transmitted to RP 114. The determination of what the number of credentials, and the value assigned to each type of credential acceptable to the relying party is preferably established as a policy by the RP 114, and is either stored at the user agent 100, or provided to user agent 100 with the request for the credential.

In the example of requiring proof of identity, the user can provide identity claims from a series of other sources that contain identity information. Such claims may be from sources including airline frequent flier groups, libraries, employers and other such public entities. The probability of a government issued credential being falsified can be quantified, and it is the fact that this probability is considered to be low makes the credential secure. The probability of any of the other credentials being falsified may be higher than the probability of the government being falsified. However, the probability of all of the sources being falsified simultaneously can be as low as the probability of the government idea being falsified. The strength of the assertion is stronger than any one of the identity claims submitted, because of the redundancy in the bundle of credentials.

It is anticipated that RP 114 can use the system illustrated in FIG. 7 and can combine credentials in a weighted fashion to provide the security desired. Thus RP 114 may require two government issued credentials, or one government issued credential along with a set of other credentials that assert identity. In the set of other credentials, the RP 114 may assign a weighting to different types of credentials. An assertion from a trusted employer may be considered as more reliable than an assertion from a library. To facilitate such a system, the user agent 100 can be provided a policy that stipulates that an aggregate response should include a sufficient number of credentials to meet a predetermined weight. The manner in which the RP 114 determines the number of identity claims required can be left as a business decision that can vary from RP to RP. The weighting system can be provided to the Identity Agent 100, which can then provide the user with an interface to select which credentials will be submitted. Thus, a user can be provided with the option to select which credentials to provide, and can determine if they want to make use of a single strong credential or a series of credentials whose strength is obtained through combination with other weaker credentials.

One skilled in the art will appreciate that the above described systems allow multiple less secure or less authoritative identity claims to be used in combination with each other. In the first embodiment, multiple sources each issuing a token provides a multi-factor authentication system with redundancy, while in the second embodiment, multiple claims (from either one or multiple sources) are used in combination to increase the strength of the identity claim.

The above-described embodiments of the present invention are intended to be examples only. Those of skill in the art may effect alterations, modifications and variations to the particular embodiments without departing from the scope of the invention, which is defined solely by the claims appended hereto.

1. A user identity agent for communicating with identity providers and relying parties in an identity management network, the identity agent comprising:
a relying party interface for receiving requests for identity information from a relying party and for transmitting an aggregated credential to the relying party in response to the received request for identity information;
an identity provider interface for transmitting requests for a credential to at least one identity provider in accordance with the received request for identity information, and for receiving the requested credential from the at least one identity provider; and
a credential processor for receiving credentials through the identity provider interface and for aggregating the credentials to create the aggregated credential transmitted to the relying party through the relying party interface.

2. The user identity agent of claim 1 wherein the requests for identity information include requests for a plurality of identification credentials.

3. The user identity agent of claim 1 wherein the identity provider interface transmits a request for a credential to a plurality of identity providers.

4. The user identity agent of claim 3 wherein the credential is a unique identifier used to identify a user to the relying party.

5. The user identity agent of claim 1 further including a database for associating a relying party with the at least one identity provider transmitting a credential supplied to the relying party.

6. The user identity agent of claim 5 wherein the database is accessible to the credential processor for storing the at least one identity provider associated with credentials aggregated and transmitted to the relying party, and the associated relying party.

7. The user identity agent of claim 6 wherein the credential processor includes an identity provider selector for selecting at least one identity provider determined in accordance with the relying party and the at least one identity provider associated with the relying party in the database, and for requesting credentials from the selected at least one identity provider through the identity provider interface in response to a request for identity information received through the relying party interface.

8. The user identity agent of claim 1 wherein the requests for identity information from a relying party include a request for a strong identity credential.

9. The user identity agent of claim 8 wherein the aggregated credential includes a set of identity credentials that in combination are acceptable to the relying party as a strong identity credential.

10. A method of registering a set of user credentials generated by a plurality of identity providers with a relying party, the method comprising:
obtaining the set of credentials from each of the identity providers in the plurality, each of the identity providers supplying one credential in the set; and
enrolling the set of credentials with the relying party by transmitting a request to associate the set of credentials with a user.

11. The method of claim 10 further including the step of storing a list of the identity providers associated with each of the credentials in the set in a database and associating the list with the relying party.

12. The method of claim 10 wherein the step of enrolling the set of credentials includes requesting that the relying party associated the set of credentials with a new user account.

13. The method of claim 12 further including storing a relying party policy specifying the number of credentials in the enrolled set required to allow a later login.

14. The method of claim 10 wherein the relying party has an existing set of credentials associated with the user, and the step of enrolling the set of credentials includes requesting that the relying party replace the existing set with the transmitted set.

15. The method of claim 14 wherein the transmitted set of credentials includes both credentials from the existing set and new credentials.

16. A method of logging in to a relying party using a set of credentials, the method comprising:
receiving a credential request from the relying party;
determining a set of credentials previously supplied to the relying party;
obtaining a subset of the determined set; and
transmitting the obtained subset to the relying party.

17. The method of claim 16 wherein the step of transmitting the obtained subset includes aggregating the subset and transmitting the aggregate to the relying party.

18. The method of claim 16 wherein the obtained subset has fewer credentials than the determined set.

19. The method of claim 18 wherein the number of credentials in the obtained subset is determined in accordance with a policy set by the relying party.
